(19) United States
(12) Patent Application Publication
(10) Pub. No.: US 2003/0065834 A1
(43) Pub. Date: Apr. 3, 2003

(54) Buffer controlling system and buffer controllable memory

(76) Inventors: Tomonao Yuzawa, Kanagawa (JP); Fumio Anekoji, Naka-gun (JP); Tetsuji Hayashi, Tokyo (JP)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/261,762

(22) Filed: Sep. 30, 2002

(30) Foreign Application Priority Data
Oct. 1, 2001 (JP) 2001-305130

(51) Int. Cl. G06F 3/00

(52) U.S. Cl. 710/52

(57) ABSTRACT

A buffer control system and a buffer controllable memory are provided that remedy the problem of increased current consumption at a time of lower clock speed. A buffer control system 10 includes a processor 100 for outputting a memory control signal 500 that determines its on/off time depending upon the clock speed, and an operation mode switching signal 800 that indicates either a high-speed operation mode or low-speed operation mode. An external memory 200, connected to the processor 100, sends and receives data, and has a bus buffer 210 whose on/off time is determined according to a memory control signal 600 input thereto. A buffer controller 900, connected between the processor 100 and external memory 200, contains a timer 400 triggered by the memory control signal 500 from the processor 100. The buffer controller 900 reduces the width of the memory control signal input from the processor for a predetermined time determined by the timer before outputting it to the external memory 200, when the operation mode switching signal 800 input thereto indicates the low-speed mode.

### FIELD OF THE INVENTION

The present invention relates to a buffer control system and a buffer controllable high-speed memory, and, more specifically, to a buffer control system and a buffer controllable high-speed memory that reduces current consumption of the buffer during a low-speed operation.

### PRIOR ART AND PROBLEM TO BE SOLVED BY THE INVENTION

A digital signal processor (DSP) used in a portable device, such as a cellular telephone, for example, needs high-speed data processing capability. However, its maximum data processing capability is not always required, as the processing load changes over time. For example, a digital radio, such as a digital cellular communication system, performs sending and receiving operation in units, called “slots”, such that its processing load is increased when processing of slots sent and received is performed, while its processing load is reduced during the remainder of the time. It may often be predicted when the processing load will increase. Because the power consumption of the processor is increased with increases in the operation clock (frequency), it is a common practice to control the operation clock according to the processing load so that the power consumption is minimized.

With a processor used in a built-in device, a small amount of internal memory is typically integrated on a processor chip. However, because its capacity is limited, a memory external to the chip is often required. When an external memory is connected to a processor operating at high speed, such as a DSP, a memory device capable of high-speed operation is used. The memory is accessed at cycles of dozens of megahertz. Thus, to charge and discharge the stray capacitance on a signal line at such speed, an external memory operable at high speed contains a buffer having a high drive capability. The buffer having a high drive capability also consumes a large amount of current (for example, 100 mA). The external memory has a control signal input for controlling the data transfer operation. By externally activating the control signal, the operation of the external memory itself and the buffer within the external memory is initiated. Typically, nearly all signals required to operate the external memory are output from the processor, so that by connecting them appropriately, the external memory can be operated.

An example of such configuration used in the prior art is illustrated in FIG. 1. Here, when a processor 100 lowers its operation clock (from 100 MHz to 1 MHz, for example) during a low load, the memory control signal width becomes longer (from 10 ns to 1 us, for example), which disadvantageously increases the current consumption in the external memory 200 because the memory control signal (for example, chip-enable signal) output by the processor becomes active (low) during a predetermined period of time, during which a bus buffer 210 becomes operative (on), thereby consuming the current. As the operation clock of the processor slows, the length, T0, of the period where the memory control signal is active is increased accordingly (see FIG. 2). Thus, there is a problem in that the period where the bus buffer 210 within the external memory 200 is operative is also increased, eventually resulting in increased current consumption. With a portable communication device, its operation clock is sometimes lowered below one-hundredth of its clock, which consumes more current by a factor of 100 than would originally be required.

Accordingly, it is an object of the present invention to provide a buffer control system and a buffer controllable memory that substantially remedy the problem of increased current consumption at a time of slower clock.

Another object of the present invention is to provide a buffer control system that achieves the afore-described remedy, while using the existing external memory and processor.

Still another object of the present invention is provide a buffer control system and a buffer controllable memory that enable high-speed access to the external memory even at a time of slower clock, while at the same time achieving low current consumption.

### BRIEF DESCRIPTION OF THE DRAWINGS

FIG. 1 is a block diagram illustrating a processor and an external memory according to the prior art.

FIG. 2 is a diagram depicting the timing of the memory control signal of FIG. 1.

FIG. 3 is a block diagram of a first embodiment of the present invention.

FIG. 4 is a diagram illustrating the inside of the switch of FIG. 3.

FIG. 5 is a diagram depicting the timing of the memory control signal of FIG. 3.

FIG. 6 is a block diagram of a second embodiment of the present invention.

FIG. 7 is a diagram depicting the timing of the memory control signal of FIG. 6.

### DETAILED DESCRIPTION OF THE INVENTION

A first embodiment of the present invention is described below with reference to the drawings. FIG. 3 shows a block diagram of a buffer control system 10 according to the first embodiment. The buffer control system 10 comprises a digital signal processor 100, an external memory 200, and a buffer controller 900. The processor 100 typically includes a clock generator 120 that generates operating frequencies, an internal memory 110, an arithmetic unit 140, and a bus buffer 130. It outputs an address signal to the external memory 200, and sends and receives data to and from the external memory 200. The processor 100 outputs a memory control signal 500 (for example, a chip-enable signal) for controlling the operation (on/off) of the bus buffer within the external memory 200. Further, it outputs an operation mode switching signal 800 to indicate whether the processor is operating in high-speed mode or in low-speed mode.

The external memory 200, which is a conventional high-speed memory, has a memory cell 220 and a high-speed bus buffer 210.

The buffer controller 900, which includes a switch circuit 300 and a timer 400, is connected between the processor 100 and external memory 200. In the present embodiment, the memory control signal is not directly input from the processor to the external memory, but the buffer controller 900 controls the timing of the memory control signal 500 from the processor 100. The memory control signal 600 so controlled is input to the external memory 200. The configuration of the switch circuit 300 is shown in FIG. 4. The operation mode switching signal 800 controls the switch circuit 300.

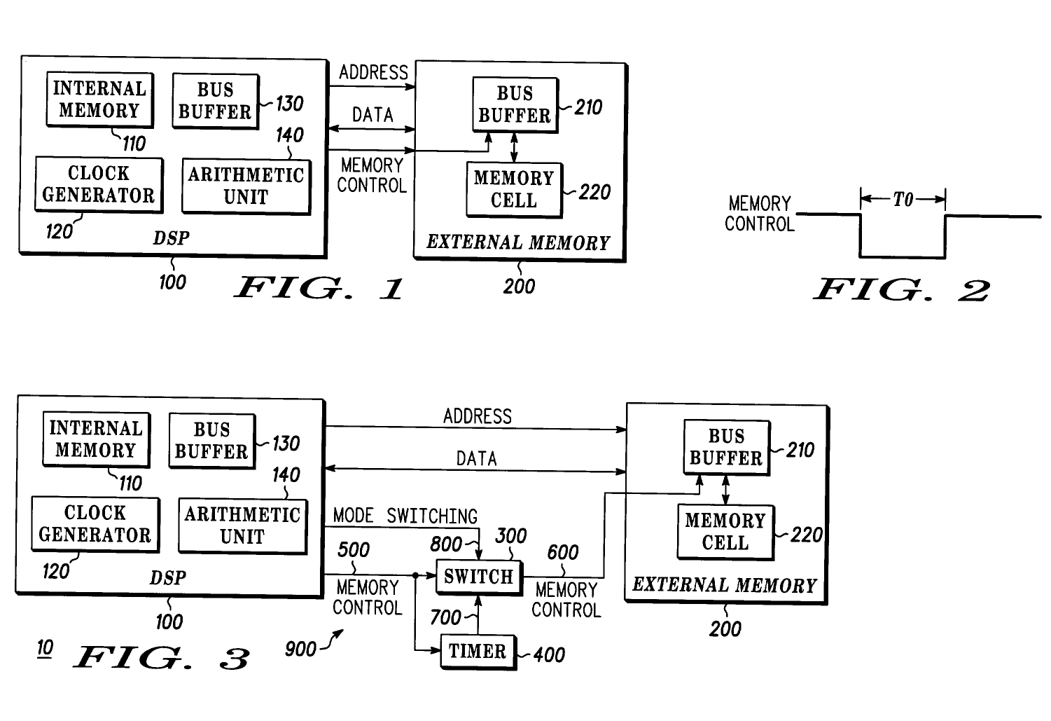

As shown in FIG. 4, when the processor 100 is operating at its normal speed (for example, in high-speed mode running at 100 MHz), the switch circuit 300 is connected to the upper side, which directly connects the memory control signals 500 and 600, so that the operation is the same as in the prior art configuration of FIG. 1. On the other hand, when the operation mode switching signal 800 indicates the low-speed clock operation (for example, 1 MHz) of the processor 100, the switch circuit 300 is connected to the lower side. In this case, an AND gate is placed between the memory control signals 500 and 600, and this AND gate is controlled by an output signal 700 from the timer 400 so that the memory control signal 500 (having a width of 1000 ns, for example) can be stopped for a time, T1 (for example, 950 ns), determined by the timer 400.

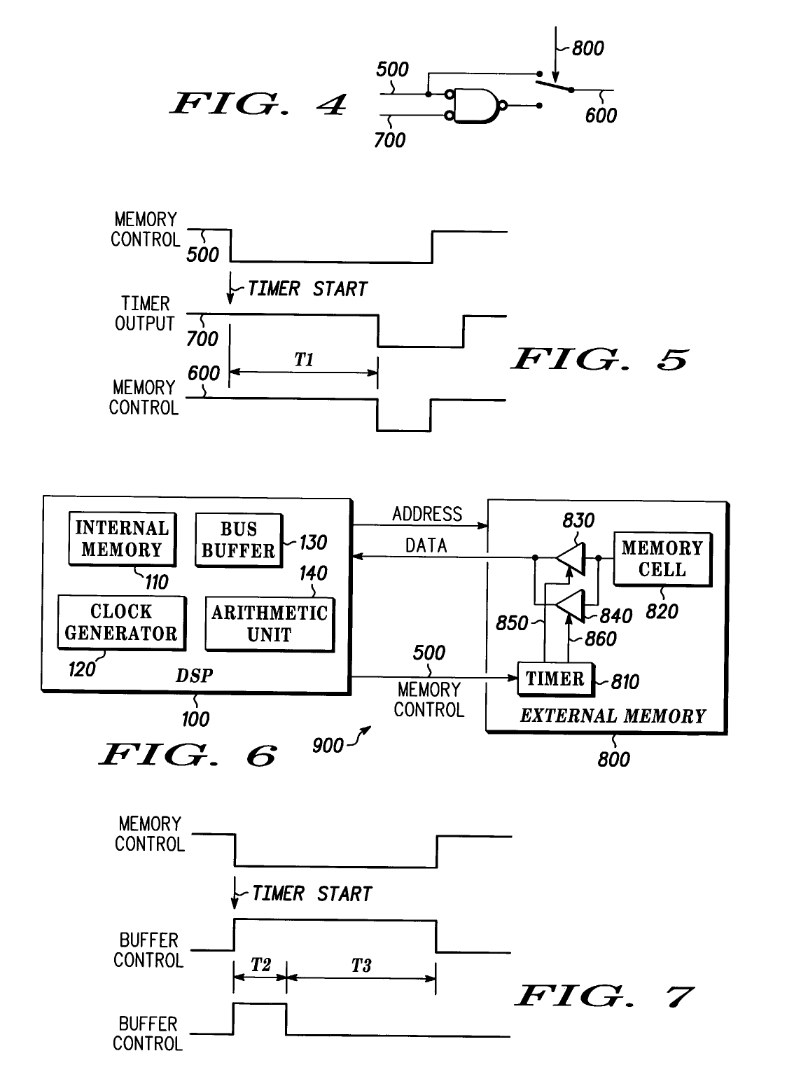

The timing chart is depicted in FIG. 5. The timer 400 starts counting at a time when the memory control signal 500 becomes low (the Timer Start point in the figure). Until a predetermined time has elapsed, the timer output signal 700 remains high, and the converted memory control signal 600 remains high, so that the bus buffer 210 of the external memory 200 is not driven. Next, at a time when the predetermined timer time T1 has elapsed, the timer output signal 700 becomes active low, and the memory control signal 600 also becomes active low, so that the bus buffer 210 of the external memory 200 is driven. Thus, during the time interval T1, the driving of the bus buffer 210 is inhibited, so that the power consumption during that time can be saved (95% saving, for example). The processor 100 reads the data over the data bus at the end of the chip-enable signal turn-on. Thus, it is at the last timing of the period where the memory control signal 500 is low that the data is actually read from the external memory in the low-speed mode. During the time period T1, even if the operation of the bus buffer 210 is stopped, data reading is not adversely affected.

In the present embodiment, it is necessary to know which operating speed mode the processor is in by use of the operation mode switching signal 800, but low current consumption can be realized without adding anything to the existing processor and external memory.

FIG. 6 shows a second embodiment of the present invention. The configuration of the present embodiment differs from the one shown in FIG. 1 in the internal architecture of the external memory 800, which has two buffers 830 and 840 as bus driving buffers, and a timer 810. It is configured so that two buffers, the low power consumption buffer 830 with a small drive capability (consuming 5 mA, for example) and the high power consumption buffer 840 with a greater drive capability (consuming 100 mA, for example), are controlled by control signals 850 and 860 according to the timer 810.

The timing chart for those signals is shown in FIG. 7. Counting is started at a time when the memory control signal 500 becomes low (the Timer Start point in the figure); at that moment, the control signals 850 and 860 to both of the buffers are immediately made high, thereby starting to drive both of the buffers. Next, after a timer time, T2 (for example, 50 ns), has passed, the control signal 860 to the buffer 840 with a greater drive capability is made low, thereby stopping the driving of the buffer 840. Thereafter, the memory control signal 500 becomes high, and, until access to the memory is completed, only the buffer 830 with a small drive capability is driven, thereby maintaining the data over the bus.

When the processor 100 reads out the data in the high-speed mode, the “low” segment of the memory control signal 500 is not long, and the data readout is completed before T2 has elapsed, so that the high-speed buffer 840 is used as usual. When the processor 100 reads out the data in the low-speed mode, the “low” segment of the memory control signal 500 is long enough; as such, if the timer did not perform buffer control, the high power consumption buffer 840 would consume large amounts of current during the time of T2+T3. According to the present embodiment, because the operation of the buffer 840 is stopped after the time T2 has elapsed, current consumption is significantly decreased during the time T3 (950 ns, for example). Even after the time T2 has passed, the low power consumption buffer 830 remains operative, so that the data over the data bus is still maintained. At the last timing of the period where the memory control signal 500 is low, the processor 100 reads the data.

The present embodiment consumes somewhat more power than the first embodiment because the buffer with a small drive capability is always driven; however, it offers an advantage in that the need to know the operating mode of the processor as in the first embodiment is eliminated, thereby allowing greater flexibility for mixed high- and low-speed accesses.

With the first embodiment described above, by using the existing memory and providing the switch 300 and timer 400, the timing of the memory control signal 500 is controlled so that the bus of the memory can be driven only for a minimum time required even when the processor 100 is operating at slower clocks, thereby advantageously reducing the power consumption related to the bus driving for the memory.

With the second embodiment of the present invention, by controlling the bus buffer within the memory stepwise, the drive capability of the bus buffer is optimized over time, thereby advantageously reducing the power consumption related to the bus driving for the memory regardless of the access speed.

1. A buffer control system (10), comprising:
a processor (100) for outputting a memory control signal (500) that determines its on/off time depending upon the clock speed, and an operation mode switching signal (800) that indicates either a high-speed operation mode or low-speed operation mode;
an external memory (200), connected to the processor (100), for sending and receiving data, and having a bus buffer (210) whose on/off time is determined according to a memory control signal (600); and
a buffer controller (900), connected between the processor (100) and external memory (200), containing a timer (400) triggered by the memory control signal (500) from the processor (100), said buffer controller (900) reducing the width of the memory control signal inputted from the processor for a predetermined time determined by the timer before outputting it to the external memory (200), when the operation mode switching signal (800) inputted indicates the low-speed mode.

2. The buffer control system according to claim 1, wherein:
said buffer controller outputs the memory control signal (500) received, with its beginning portion disabled and only its trailing portion enabled.

3. A buffer controller (900), which may be connected between:
a processor (100) that outputs a memory control signal (500) that determines its on/off time depending upon the clock speed, and an operation mode switching signal (800) that indicates either a high-speed operation mode or low-speed operation mode; and
an external memory (200), connected to the processor, capable of sending and receiving data, said external memory having a bus buffer (210) whose on/off time is determined according to a memory control signal (600) input thereto,
wherein said buffer controller (900) comprises:
a timer (400) triggered by the memory control signal (500) from the processor (100), and reducing the width of the memory control signal input from the processor for a predetermined time determined by the timer before outputting it to the external memory, when the operation mode switching signal (800) input thereto indicates the low-speed mode.

4. A memory (800), connectable to a processor (100) that outputs a memory control signal (500) for determining the memory on/off time depending upon a clock speed, the memory also capable of sending and receiving data to and from the processor, comprising:
a high-speed bus buffer (840), a low-speed bus buffer (830), and a timer (810);
wherein the high-speed bus buffer and low-speed bus buffer are turned on by the memory control signal (500); and
the timer (810) is triggered by the memory control signal (500) and turns off the high-speed bus buffer (840) after a predetermined time has elapsed.
